(19) United States
(12) Patent Application Publication
(10) Pub. No.: US 2017/0277898 A1
(43) Pub. Date: Sep. 28, 2017

(54) KEY MANAGEMENT FOR SECURE MEMORY ADDRESS SPACES

(71) Applicant: Advanced Micro Devices, Inc., Sunnyvale, CA (US)

(72) Inventors: Jeremy W. Powell, Austin, TX (US); David A. Kaplan, Austin, TX (US); Jesse D. Larrew, Austin, TX (US); Thomas R. Woller, Austin, TX (US); Joshua Schiffman, Bristol (GB)

(21) Appl. No.: 15/081,126

(22) Filed: Mar. 25, 2016

(51) Int. Cl. G06F 21/60; G06F 21/62

(52) U.S. Cl. CPC G06F 21/602; G06F 21/6218

(57) ABSTRACT

A processor employs a security module to manage authentication and encryption keys for the processor. The security module can authenticate itself to other processing systems, such as processing systems providing software to be executed at the processor, can generate keys for encrypting address spaces for the provided software, and can securely import and export information at the encrypted address spaces to and from the processing system. By using a security module that is separate from the processor cores of the processor to perform these security operations, the processing system allows software executing on the processor cores to manage operations based on the authentication and encryption keys without being able to read the keys themselves, thereby preventing unauthorized access by malicious software to the keys.

### BACKGROUND

Field of the Disclosure

The present disclosure relates generally to processing systems and more particularly to key management for information security at a processing system.

Description of the Related Art

In many processor applications, protection of information security is an important feature. For example, a processing system can be used in a server in an Infrastructure As A Service (IAAS) environment, wherein the processor executes one or more virtual machines (VMs) and executes a hypervisor to partition the server hardware among the VMs and isolate the VMs from each other. Because different VMs may be executed on behalf of different customers, it is desirable that the information (instructions and data) employed by each VM be protected from access by other VMs. Conventionally, the hypervisor maintains isolation of VM information by maintaining separate memory page tables and other logical entities for each VM. However, flaws (e.g., bugs) in the hypervisor can cause the hypervisor itself to be vulnerable to exploitation, allowing one VM (or other software such as a set of administrative tools) to access the information of another VM. Even in personal security environments, such as personal computers, data stored in memory modules can be subject to theft, and the data stored therein subject to unauthorized access. Both corporate and personal security environments can be made more secure by employing a processor that supports independent encryption of data for each VM. However, the keys used to encrypt VM data can themselves be subject to access by the hypervisor, rendering the encrypted data vulnerable to unauthorized access.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system employing an encryption module at a memory controller for secure isolation of information and a security module to manage keys for encryption and authentication of the processing system to access the isolated information in accordance with some embodiments.

FIG. 2 is a block diagram illustrating isolation of encryption and authentication keys at the security module of FIG. 1 in accordance with some embodiments.

FIG. 3 is a block diagram illustrating an example of the processing system of FIG. 1 authenticating the security module to another processing system in accordance with some embodiments.

FIG. 4 is a block diagram illustrating and example of the processing system of FIG. 1 attesting to the integrity of launching a software entity in accordance with some embodiments.

FIG. 5 is a block diagram illustrating states of the security module of FIG. 1 that together prevent unauthorized access to encryption and authentication keys of the processing system in accordance with some embodiments.

FIG. 6 is a block diagram illustrating states of a guest virtual machine (VM) executing at the processor of FIG. 1, wherein the security module manages states of the guest VM to prevent unauthorized access to encryption and authentication keys of the processing system in accordance with some embodiments.

FIG. 7 is a flow diagram of a method of authenticating the security module of FIG. 1 to another processing system in accordance with some embodiments.

FIG. 8 is a flow diagram of a method of launching a VM at the processor of FIG. 1 to encrypt an address space associated with the VM in accordance with some embodiments.

FIG. 9 is a flow diagram of a method of sending a guest VM from the processing system of FIG. 1 to another processing system while maintaining security for an address space of the guest VM in accordance with some embodiments.

FIG. 10 is a flow diagram of a method of receiving a guest VM at the processing system of FIG. 1 to another processing system while maintaining security for an address space of the guest VM in accordance with some embodiments.

### DETAILED DESCRIPTION

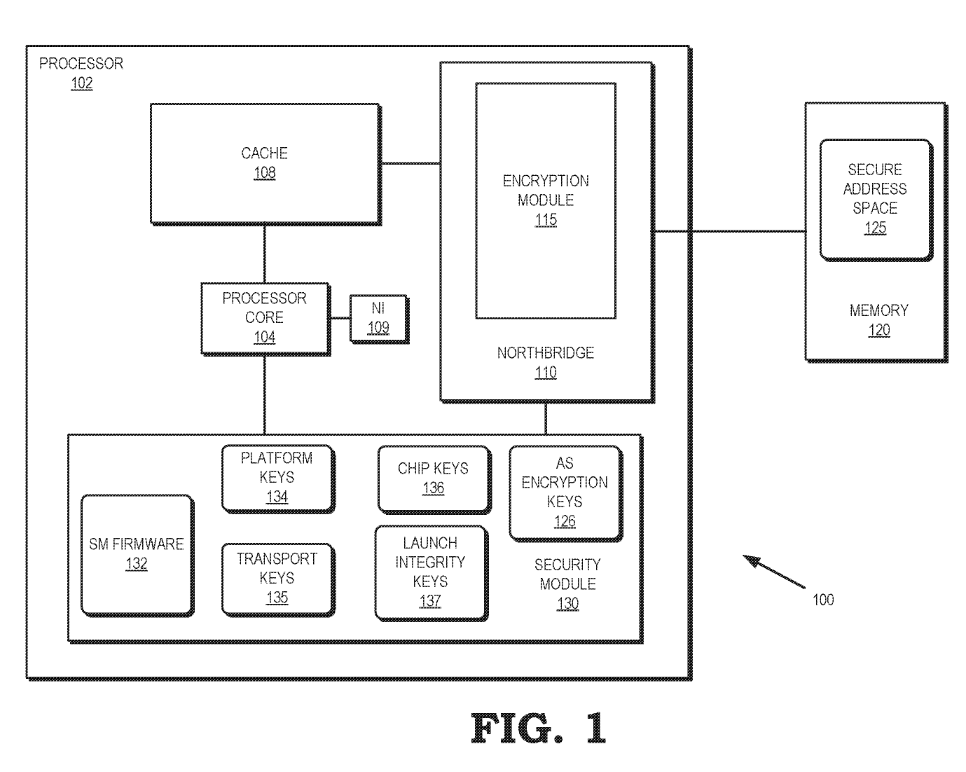

FIGS. 1-10 illustrate techniques for supporting address security operations at a processing system by employing a processor with a security module, wherein the security module manages authentication and encryption keys for the processor. In particular, the security module can authenticate itself to other processing systems, such as processing systems providing software to be executed at the processor, can generate keys for encrypting address spaces for the provided software, and also can securely import and export information at the encrypted address spaces to and from the processing system. By using a security module that is isolated from processor cores of the processor to perform these security operations, the processing system allows software executing to manage operations based on the authentication and encryption keys without being able to read the keys themselves, thereby preventing unauthorized access to the keys by malicious software.

To illustrate via an example, in some embodiments the processing system can execute a hypervisor that supports execution of different guest virtual machines (VMs). To protect each guest VM from unauthorized access, the hypervisor can assign each VM to a corresponding encrypted address space. In response to requests from the hypervisor, the security module can generate authentication keys to authenticate the security module and encryption keys to encrypt data to be stored at the encrypted address space for the VM. In some embodiments, the encryption is performed at a memory controller of the processing system, wherein the security module provides the encryption keys directly to the memory controller, such that the hypervisor cannot access the encryption keys. Thus, the keys for authentication of the security module and for encryption of corresponding address spaces are generated and maintained by the firmware of the security module in response to requests from the hypervisor. The authentication and encryption keys are therefore not accessible by the hypervisor, preventing a flawed or malicious hypervisor from accessing the keys and thereby reading information, at the encrypted address space, that the hypervisor is not authorized to read.

In some embodiments the security module performs at least four different security functions. First, the security module can authenticate itself to external processing systems, such as the processing system of a software owner (referred to as the requestor processing system) that wishes to execute software at the processing system including the security module. For example, in response to receiving a request to execute a guest VM, the security module can provide to the requestor a platform key that is unique to the security module. The requestor can authenticate the key according to conventional key authentication techniques and, in response to determining that the key is authentic, provide the processing system of the security module the guest VM to be executed. The security module authentication function prevents malicious software from impersonating the security module to the requestor and thereby gain unauthorized access to the guest VM.

Second, the security module can perform an attestation function wherein it provides to the requestor proof of the integrity and proper initialization of the guest VM. For example, during launch of the guest VM at the processing system of the security module, the security module can record state information for the guest VM as it launches and create a signature based on the states using a generated launch integrity key. The security module provides the signed state information to the requestor, which authenticates the signature and compares the signed state information to expected state information. In some embodiments, the requestor does not provide the VM with selected confidential information until the state information has been authenticated and determined to match the expected state information. This security function prevents a malicious hypervisor from interfering with the launch of the guest VM in a way that allows the hypervisor to access confidential data of the guest VM.

Third, the security module can support maintaining confidentiality of guest VM data while the guest VM is executing at the processing system. For example, the security module can generate an encryption key for the guest VM and provide those encryption keys to an encryption module at a memory controller of the processing system. The encryption module employs the encryption key to encrypt an address space for the VM. The security module provides the encryption key directly to the encryption module, so that it is not accessible to a hypervisor or other software executing at the processing system. This prevents a flawed or malicious hypervisor from accessing the guest VM's secure data.

Fourth, the security module supports migration of the guest VM to another processing system while maintaining the confidentiality of the guest VM's secure data while the guest VM is migrated to another processing system. For example, in response to a request from the requestor to migrate the guest VM to the requestor, the security module can generate transport encryption keys and encrypt the guest VM, including its secure data, with the transport encryption keys. The security module then provides the encrypted guest VM to the requestor, which decrypts the guest VM, re-encrypts the guest VM with a locally generated address space encryption key, and executes the guest VM. By encrypting the guest VM prior to migration, the security module protects the secure data of the guest VM during the migration process.

The security module is independent of the processor cores of the processor, either physically by employing separate hardware from the processor cores to execute its operations, or logically, by executing its operations using the same hardware as the processor cores, but in a different mode of execution so that software executing at the processor cores cannot access data of the security module. Thus, while software executing at the processor cores may invoke operations of the security module, the operations themselves are not controlled by the software executing at the processor cores, nor are the results of any operation requested by the software independently accessible by the software. That is, any results of an operation of the security module are only provided to the processor cores based on the operations of the security module itself and are not stored at registers that are directly accessible to the processor cores nor otherwise stored such that the results can be accessed by the software executing at the processor cores.

Because of its independence from the processor cores, the security module protects the keys, including platform keys, launch integrity keys, and transport keys from unauthorized access by isolating the keys from software executing at the processor. As used herein, isolating the keys refers to generating and storing the keys such that they cannot be accessed by any instruction executing at a processor core of the processor. The security module isolates the keys using a combination of techniques. First, the security module employs hardware isolation from the processor cores executing software. That is, the circuitry used to generate the keys cannot be accessed by the processor cores, and any registers or other storage elements used to store the keys are not addressable or otherwise accessible to any instruction executing at the processor cores. Further, any communication of keys by the security module to other parts of the processor are performed directly, without employing the processor cores as an interface.

Second, the security module supports isolation of the keys by employing state management, both for its own state and for the state of software executing at the processor cores. In particular, the security module ensures that generation and storage of the keys is performed during an initialization state of the security module, prior to the security module allowing execution of software entities, such as guest VMs, at the processor cores. This ensures that malicious software cannot execute during periods when the keys might be vulnerable to access, such as during generation of the keys.

Third, the security module supports isolation of the keys by providing to software executing at the processor cores only public keys of private-public key pairs generated at the security module. This allows the software to conduct security operations with other processing systems, such as authentication and migration operations, without exposing the keys to access by the software.

FIG. 1 illustrates a processing system 100 that provides for cryptographic protection of information in accordance with some embodiments. The processing system 100 includes a processor 102 and a memory 120. The processing system 100 can be incorporated in any of a variety of electronic devices, such as a server, personal computer, tablet, set top box, gaming system, and the like. The processor 102 is generally configured to execute sets of instructions (e.g., computer programs) that manipulate the circuitry of the processor 102 to carry out defined tasks. The memory 120 facilitates the execution of these tasks by storing data used by the processor 102. The memory 120 can be random access memory (RAM), non-volatile memory such as flash memory or a hard disk drive (HDD), and the like, or a combination thereof

In the course of executing the sets of instructions, the processor 102 generates memory access requests, including write requests to store data at the memory 120 and read requests to retrieve data from the memory 120. Each memory access request includes a memory address (e.g., a system physical address) indicating a location at the memory 120 targeted by the memory access request. In response to a read request, the memory 120 retrieves information (data or instructions) stored at the location corresponding to the memory address of the read request and provides the information to the processor 102. In response to a write request, the memory 120 stores write information of the request at the location corresponding to the memory address of the write request.

The processor 102 also includes a network interface (NI) 109 that provides an interface to a network (not shown) such as a wide area network (e.g., the Internet), a local area network, or a combination thereof. The NI 109 facilitates communication between software executing at the processor 102 and other processing systems to conduct authentication operations, attestation operations, and other operations described herein.

The processor 102 includes a security module 130. The security module 130 may be, for example, a general purpose processor, a field programmable gate array (FPGA), an application specific integrated circuit (ASIC), or other module designed and configured to perform security operations for the processing system 100, including registration of entities (e.g., virtual machines, computer programs, and the like) to be executed at the processor 102, generation and identification of security keys for the entities to be executed, authentication of the processing system 100 for security operations, and the like. In some embodiments, the security module 130 may undergo a secure registration process before it is permitted to execute its operations, and may have its operations restricted to security operations only, so that it cannot execute operations that leave it vulnerable to exploitation.

In some embodiments, the security module 130 executes security module (SM) firmware 132 to control its operations. In some embodiments, the operations of the SM firmware 132 described herein can instead be hardwired into the circuitry of the security module 130. The SM firmware 132 enforces security at the processor 102 in at least two interrelated ways. First, the SM firmware 132 monitors states of the security module 130 and states of software (such as guest VMs and a corresponding hypervisor) executing at the processor 102 and restricts certain security operations (such as generation or communication of security keys or signatures) to states wherein the security operations are less vulnerable to exploitation. Second, the SM firmware 132 generates and maintains a set of keys and associated signatures, and restricts access to those keys and signatures to prevent exploitation. For ease of description, the term “key” is used herein to refer to an authentication or encryption key, as well as any certificate, or certificate chain, that signs the key. In the example of FIG. 1, the SM firmware 132 generates and maintains five sets of keys: platform keys 134, transport keys 135, chip keys 136, launch integrity keys 137, and address space (AS) encryption keys 126.

The chip keys 136 are one or more keys that are uniquely associated with the processor 102 itself. In at least one embodiment, the SM firmware 132 can generate the chip keys 136 based on a secret data, referred to herein as a chip secret, stored at a set of one-time-programmable (OTP) fuses (not shown). The chip secret can be programmed into the OTP fuses by a manufacturer of the processor 102 such that the chip secret differentiates the processor 102 from other processors produced by the manufacturer. In some embodiments, the SM firmware 132 generates the chip keys 136 based on the chip secret using a key derivation function (KDF). In some embodiments, the chip keys 136 are not used directly by the security module 130 in authentication, attestation, or other security operations, but instead are used to sign other keys, such as the platform keys 134, to indicate that the other keys have been generated by a processing system including a properly designed and manufactured security module, rather than generated by a malicious processing system or software.

The platform keys 134 are one or more keys that are associated with the processing system 100, supporting authentication of the processing system 100 to other processing systems and entities. For example, the platform keys 134 can be employed by the security module 130 to interact with other entities in a secure manner, such as interacting with processing systems or other entities that wish to authenticate that the processing system 100 includes the security module 130 prior to providing a software entity to the processing system 100 for execution, or otherwise granting the processing system 100 permission or access to execute the software entity. In some embodiments, the platform keys 134 include a platform endorsement key pair, collectively referred to as the PEK. In an initialization state, the SM firmware 132 generates the PEK according to a conventional key generation protocol and signs the PEK using one or more of the chip keys 136. The PEK is thereby uniquely associated both with the processor 102 (via the chip key signature) and with the software platform provided by the processing system 100 (via generation of the PEK during initialization). The PEK may also be signed by other entities, such as an owner of the processing system 100 to uniquely associate the PEK with the owner.

In some embodiments the platform keys 134 also include one or more public keys that can be shared with other devices and software according to a conventional key exchange protocol. For purposes of description, it is assumed that the platform keys 134 include a key, referred to herein as a PDH key, that complies with the Diffie-Hellman key exchange protocol. As described further herein, the PDH key can be generated by the SM firmware 132 during an initialization state of the firmware or during a working state of the SM firmware 132 wherein one or more software modules, such as guest VMs, are permitted to execute at the processor 102. The SM firmware 132 can sign the PDH key with the PEK to uniquely associate the PDH key with both the processor 102 and the software platform supported by the SM firmware 132.

As described further herein, the security module 130 also supports the cryptographic isolation of information at the processing system 100 into areas of the memory 120 referred to as secure address spaces. To illustrate, the processor 102 includes a processor core 104, a cache 108, and a northbridge 110. The processor core 104 is a processing unit that can execute instructions at an instruction pipeline that fetches instructions, decodes the fetched instructions into corresponding operations and, using the resources of the processing system 100, executes the operations, including memory access requests. The processor core 104 is configured to identify each memory access request as one of two types: a secure memory access request, indicating that the information corresponding to the memory access request is designated for cryptographic protection, or a non-secure memory access request, indicating that the information corresponding to the memory access request is not designated for cryptographic protection.

In some embodiments, the processing system 100 implements a security scheme whereby the security designation for information (whether the information is to be cryptographically protected) is assigned based on control bits included with the memory address corresponding to where the information is stored at the memory 120 or corresponding to the type of information (e.g., instructions or data). This allows large collections of data to be easily classified as secured information, providing for efficient information protection. For example, in some embodiments, the control bits are set by the processing system 100 so that particular types of information, such as instruction information, or page table information that provides a mapping of virtual addresses to physical addresses of the memory 120, are designated as secured information, thereby cryptographically protecting this information as described further below. The control bits for addresses assigned to data can be designated in a more fine-grained fashion based on, for example, designations requested by programs executing at the processor 102. This security scheme provides for protection of crucial data (preventing, for example, unauthorized execution of a virtual machine or its programs) while still providing flexibility for more general data.

In some embodiments, because the security type assigned to information is designated based on the information's corresponding memory address, the processing system 100 uses the page tables themselves to indicate the security type for each memory address. Accordingly, the processor core 104 identifies the type of memory access request in the course of identifying the memory address corresponding to the memory access request. In particular, if the memory address is indicated as storing secured information, the corresponding memory access is identified as a secure memory access. Similarly, if the memory address is indicated as storing non-secured information, the corresponding memory access is identified as a non-secure memory access.

The cache 108 is a memory device that stores subsets of the information stored at the memory 120, thereby providing the processor core 104 quick access to the respective information subset. It will be appreciated that although for simplicity the cache 108 is illustrated as a single cache, in some embodiments the cache 108 can represent multiple caches, including different caches residing at different levels of a memory hierarchy of the processor 102. The cache 108 receives memory access requests and identifies whether its storage array (not shown at FIG. 1) stores information targeted by the memory access request. If so, the cache 108 indicates a cache hit and satisfies the memory access request at the storage array. If the cache 108 does not store the targeted information, it indicates a cache miss and provides the memory access request to the northbridge 110.

In the illustrated example of FIG. 1, the memory access path of the processing system 100 is such that the cache 108 stores information, including secure information, in an unencrypted form. Accordingly, in some embodiments the cache 108 stores, for each storage location of a given size (e.g., a cache line), entity tag information identifying a particular program or other entity (e.g., a VM) that is authorized to access the information at the storage location. In response to a memory access to a location of the storage array, the cache 108 compares the identity of the entity that generated the memory access request to the entity tag information and, in response to a mismatch, indicates a cache miss, thereby preventing unauthorized access to the information.

The northbridge 110 is a memory controller that provides an interface for the processor 102 to communicate with the memory 120. In some embodiments, the northbridge 110 can perform other functions, such as interfacing with an input/output controller (e.g., a southbridge, not shown), and providing an interface between different processor cores, such as a graphics processing unit. In its capacity as a memory controller, the northbridge 110 receives memory access requests from the cache 108 and controls provision of those requests to the memory 120. In addition, the northbridge 110 receives responses to memory access requests from the memory 120 and controls provision of the responses to the cache 108. In some embodiments, the northbridge 110 can receive memory access requests (e.g., direct memory access requests) from input/output devices (not shown) of the processing system 100 and controls their provision to the memory 120.

To provide for cryptographic isolation of information, the northbridge 110 includes an encryption module 115 configured to encrypt and decrypt information according to a specified cryptographic standard, and based on the address space (AS) encryption keys 126. In some embodiments, the encryption module 115 is configured to employ Advanced Encryption Standard (AES) encryption and decryption, but in other embodiments the encryption module 115 may employ other encryption/decryption techniques. In response to receiving a write request, the northbridge 110 identifies whether the request is a secure memory access request or a non-secure memory access request. If the write request is a non-secure memory access request, the northbridge 110 bypasses the encryption module 115 and provides the write request to the memory 120 without encrypting the information to be written. If the write request is a secure memory access request, the northbridge 110 identifies one of the AS encryption keys 126 that is assigned to the entity (e.g., program, VM, software service, and the like) that generated the memory access request. In some embodiments, the security module 130 identifies the key to be selected based on which entity is currently being executed at the processor 102. The encryption module 115 employs the selected key to encrypt the information to be written and provides the write request, with the encrypted information, to the memory 120 for storage. In some embodiments, the encryption module 115 uses both the selected key and the physical address of the memory access request for encryption and decryption of the corresponding information thereby preventing block move attacks. In some embodiments, the SM firmware 132 generates the AS encryption key 126 for an entity in response to a request from that entity to execute at the processor 102.

The SM firmware 132 can also protect the secure address space 125 in other ways, such as by generating the AS encryption keys 126 itself in response to a request to execute a software entity and providing the keys directly to the northbridge 110, such as by writing the keys directly to registers of the northbridge 110. These registers can be inaccessible to (e.g., not addressable by) a hypervisor or other entities executing at the processor 102, thus preventing malicious entities from accessing the AS encryption keys 126 and in turn accessing the secure address space 125.

In some embodiments, the SM firmware 132 can monitor the entity as it launches (initiates execution) at the processor 102 and record state information based on the states the entity moves through as it launches. For example, the SM firmware 132 can monitor the number of memory locations at the memory 120 that the entity encrypts. The SM firmware 132 can sign the state information with the launch integrity key 137 generated based on the PEK key, and provide the signed state information to another platform, such as trusted platform run by a third party or by the owner of the entity. The trusted platform can authenticate the signed state information and compare the authenticated state information to expected state information. In response to a mismatch or a failure to authenticate the state information, the trusted platform can take remedial action, such as indicating to the SM firmware 132 that the entity is not to access the secure address space 125, refusing to send to the entity security keys to access stored information, and the like.

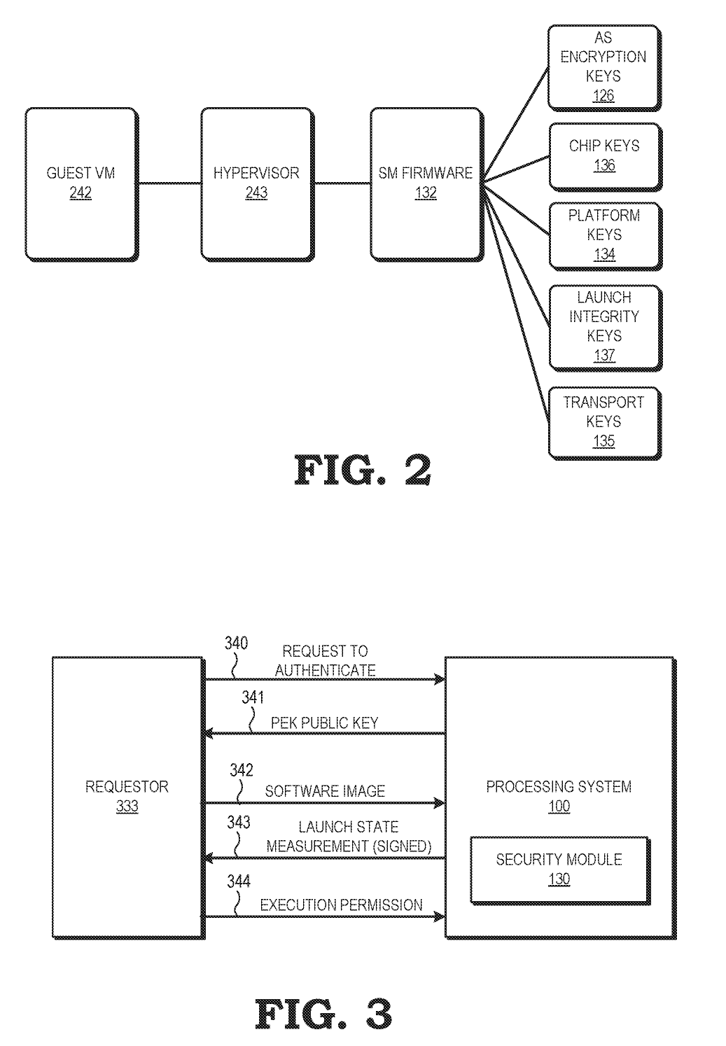

The SM firmware 132 protects the secure address space 125 from unauthorized access by isolating the keys, including the platform keys 134, chip keys 136, AS encryption keys 126, transport keys 135, and launch integrity keys 137 from potentially malicious software. An example is shown at FIG. 2 in accordance with some embodiments. In the example of FIG. 2, the processor 102 executes a hypervisor 243 that manages execution of one or more guest VMs, such as guest VM 242. Conventionally, the hypervisor 243 would interact directly with the processor 102, and therefore have access to all security keys associated with the guest VM 242, including AS encryption keys 126 used to encrypt an address space for the VM. This would allow a malicious or flawed hypervisor to provide access to secure information of the VM to an unauthorized party. In contrast, in the example of FIG. 2, any access to security keys by the hypervisor 243, such as the AS encryption keys 126, the chip keys 136, the platform keys 134, the transport keys 135, and the launch integrity keys 137 are managed by the SM firmware 132 as described further herein. In particular, the SM firmware 132 can manage all encryption of secure data for a VM by controlling the generation and storage of the AS encryption keys 126, can control authentication of the processing system 100 to other processing systems requesting to execute guest VMs and other software at the processor 102 by controlling the generation and storage of the platform keys 134, and the like, thereby preventing malicious software from improperly accessing a secure address space for the guest VM 242.

FIG. 3 illustrates a block diagram of an example of the processing system 100 communicating with another processing system, labeled the requestor 333, in order to authenticate the processing system 100 in accordance with some embodiments. In the example of FIG. 3, it is assumed that the requestor 333 is a processing system that provisions software entities, such as guest VMs, for execution at the processing system 100. As used herein, provisioning a software entity can include one or more of providing a software image to the processing system 100 for execution, providing an authorization code or other information necessary to execute a provided software image, providing important data for the software image to do specified operations, and the like.

In the example of FIG. 3, prior to provisioning the software entity, at 340 the requestor 333 issues, to the processing system 100 a request to authenticate—that is a request to provide information indicating that the processing system 100 includes a properly manufactured, purchased, and owned security module 130. In response, at 341 the security module 130 provides the PEK public key to the requestor 333, which authenticates the PEK public key according to a conventional public-private key authentication process. If the PEK public key is authentic, the requestor 333 provisions the software entity at 342 by providing an image of the software entity instructions to the processing system 100.

In response to receiving the image, the processing system initiates a launch of the software entity. To attest to the integrity of the launch, during the launch the security module 130 monitors state information for the launch, such as the address range of a secure address space for the software entity, the order of memory page encryption in the secure address space, and the like. The security module 130 then negotiates a launch integrity key with the requestor 333, signs the state information for the launch using the launch integrity key, and at 343 provides the encrypted launch information to the requestor 333. In response, the requestor 333 compares the signature with the signature of an expected state. In response to a match between the received signature and the expected signature and the state information, at 344 the requestor 333 provides an indication of execution permission to the processing system 100 to allow useful operation of the software entity. The indication of execution permission can take any of a number of forms, such as a code value that unlocks a locked portion of the software entity, crucial data that allows the software entity to perform useful work for the requestor 333, and the like.

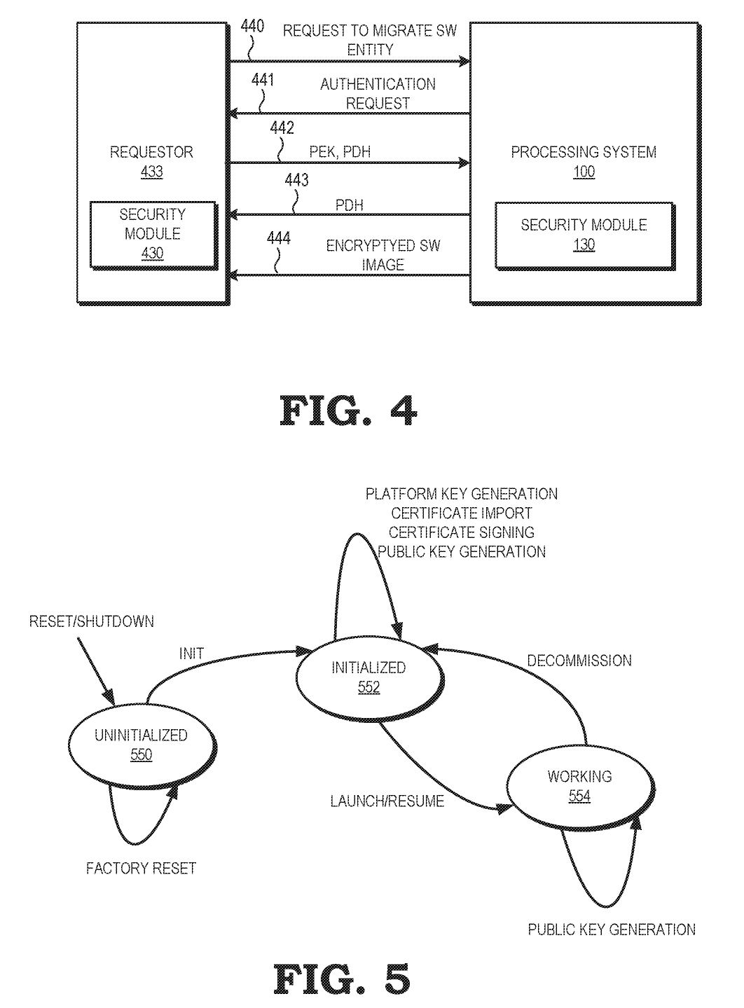

FIG. 4 is a block diagram of an example of the processing system 100 communicating with another processing system, labeled the requestor 433, in order to migrate a software entity, such as a guest VM, from the processing system 100 to the requestor 433. In the depicted example, it is assumed that the requestor 433 is a processing system that also includes a security module 430 similar to the security module 130. The requestor 433 initiates the migration at 440 by sending a request to the processing system 100 to migrate the software entity. In response, at 441 the processing system 100 sends an authentication request to the requestor 433, in order to ensure that the requestor 433 includes a security module. In response to the authentication request, at 442 the requestor 433 sends the processing system 100 its PEK public key and its PDH key. The processing system 100 authenticates the requestor 433 using the PEK public key, and at 443 also negotiates a transport key with the requestor 433 based on the PDH key and the PEK public key using a conventional key negotiation technique.

In response to authenticating the requestor 433, the security module 130 encrypts the software entity using the transport key. In some embodiments, the security module 130 first decrypts the information at the secure address space 125 for the software entity, then re-encrypts the information using the transport key. At 444, the security module 130 provides the encrypted software entity to the requestor 433, which decrypts the software entity, re-encrypts the software entity using a locally generated AS encryption key, and executes the software entity.

One technique the SM firmware 132 can employ to protect the platform keys 134 and chip keys 136 is by managing a set of states for the security module 130, and permitting selected operations only in select states. An example set of these states is illustrated at FIG. 5 in accordance with some embodiments. In the example of FIG. 5, the SM firmware 132 is placed in an uninitialized state 550 in response to a reset or shutdown indication, and remains in the uninitialized state 550 in response to a factory reset indication from executing software, such as a hypervisor. In the uninitialized state 550, the SM firmware 132 will not accept any commands from the hypervisor except the factory reset command or an initialize command, designated “INIT.”

In response to the INIT command the SM firmware 132 transitions to an initialized state 552. In some embodiments, in response to the INIT command the SM firmware 132 generates one or more of the chip keys 136 based on the chip secret stored at the set of OTP fuses. The SM firmware 132 can also generate the PEK key based on the chip keys 136 and the PDH key based on the PEK key, and store both the PEK key and PDH key at the platform keys 134. However, in the initialized state 552 the SM firmware 132 will not accept any commands from the hypervisor to launch a guest VM or other software. Accordingly, as the platform keys 134 and chip keys 136 are being generated, the SM firmware 132 is in a state where it the keys cannot be altered or regenerated while a guest VM is executing, nor receive any requests for these keys. This prevents flawed or malicious software from, for example, changing the identity of the processing system where the guest VM is executing after the guest VM has already authenticated the identity.

In the initialized state 552, the SM firmware 132 will accept a limited set of commands from a hypervisor or other software entity executing at the processor 102. One example of such commands is a platform key generation command. In response to this command, the SM firmware 132 deletes any previously generated chip keys, PEKs, and PDH keys, then generates new chip keys, a new PEK signed by the chip keys, and a new PDH key. Thus, the SM firmware 132 accepts the platform key generation command in the initialized state 552 when guest VMs and other software employing encrypted address spaces are not permitted to run (because the SM firmware 132 will not accept or execute requests to run such software). This protects the generated keys from unauthorized access while the keys are being generated, enhancing security at the processing system 100.

In the initialized state 552 the SM firmware 132 will also accept certificate import commands and certificate signing commands. In response to a certificate signing command, the SM firmware 132 generates a certificate signing request (CSR) according to a conventional CSR technique and sends the CSR to a trusted certificate authority. This allows the processor 102 to be joined to a trusted domain from which it can receive software, such as encrypted guest VMs, and other secure information. The CSR contains the identifying information of this platform and the PEK public key. The certificate authority processes the CSR by generating a certificate with the information from the CSR and signing it with its key. In response to a certificate import command, the SM firmware 132 imports the certificate and authenticates it based on the key signature. If the certificate is authentic, the SM firmware 132 can subsequently use the certificate to authenticate software and other information received from the trusted domain.

In addition, in the initialized state 552 the SM firmware 132 will accept public key generation commands, wherein in response to each command the SM firmware 132 generates a new PDH key. In some embodiments, the SM firmware 132 will maintain a single PEK and PDH at a time, and any request to regenerate the PEK or PDH key will cause the current PEK or PDH key, respectively, to be deleted.

In response to a request from the hypervisor to launch a guest VM, referred to herein as a launch request or a resume request, the SM firmware 132 transitions to a working state 554, wherein software entities such as guest VMs are permitted to execute at the processor 102. In the working state 554, the SM firmware 132 will continue to accept certificate signing commands and public key generation commands to allow the hypervisor and guest VMs to conduct secure communications and transactions, such as transfer of secure information, while the guest VM executes. However, the SM firmware 132 will not accept or execute platform key generation commands to generate new chip keys or PEKs. Instead, these keys can be maintained in secure volatile or non-volatile storage and used by the SM firmware 132 to authenticate guest VMs and perform other secure operations as described further herein. By refusing to accept platform key generation commands in the working state 554, the SM firmware 132 prevents the identity of the firmware from being changed during execution of a guest VM. To regenerate new platform keys, the SM firmware 132 must first receive a decommission command to return it to the initialized state 552. In response to the decommission command, the SM firmware 132 instructs the processor 102 to stop executing any guest VMs. Once execution of the guest VMs has been stopped, the SM firmware 132 transitions to the initialized state 552.

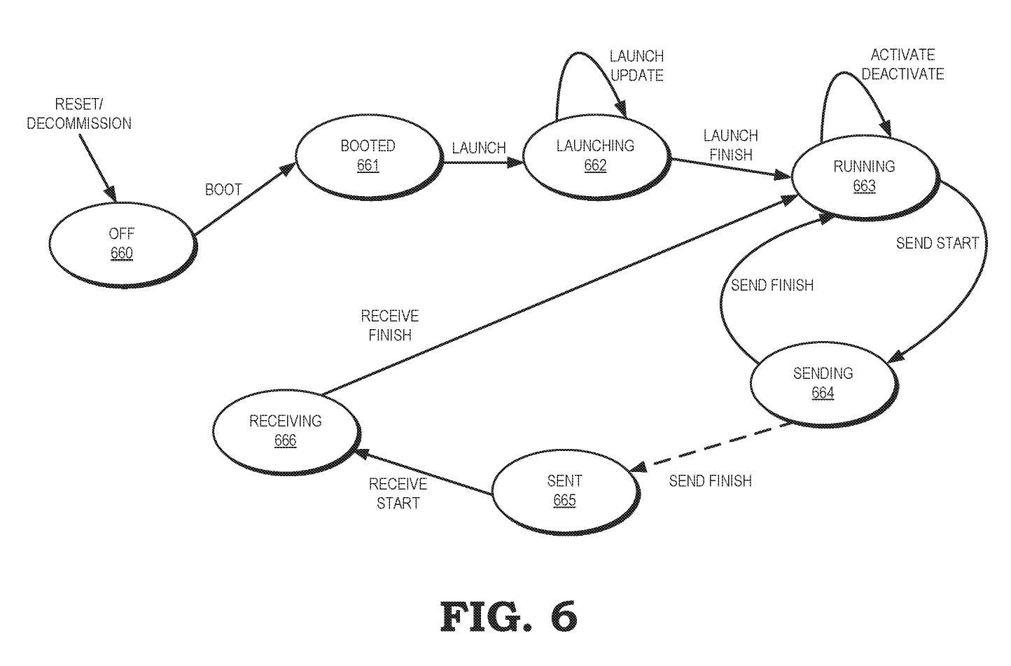

FIG. 6 illustrates a block diagram of states of a guest VM as monitored and regulated by the SM firmware 132 in accordance with some embodiments. When a guest VM is provisioned at the processing system 100, the SM firmware 132 first identifies the guest VM as being in an off state 660. In response to an indication from the hypervisor 243 that it has booted the guest VM so that it is ready for execution, the SM firmware 132 transitions the guest VM to a booted state 661. The hypervisor 243 then sends a launch command to the SM firmware 132.

In response to the launch command, the SM firmware 132 places the guest VM in a launching state 662. In this state, the SM firmware 132 generates an AS encryption key for the guest VM and provides the AS encryption key directly to the encryption module 115. The SM firmware 132 further instructs the encryption module 115 to initiate encryption of any secure information for the guest VM using the corresponding AS encryption key. While in the launching state 662, the hypervisor 243 can send launch update commands to the SM firmware 132, indicating additional pages or other units of data that are to be encrypted and in response the SM firmware 132 can instruct the encryption module 115 to encrypt the indicated data units. However, the SM firmware 132 does not provide the AS encryption key for the guest VM to the hypervisor 243, thereby protecting the secure data from exploitation.

Once the hypervisor 243 identifies that all secure pages or other units of data have been encrypted, it sends a launch finish command to the SM firmware 132. In response, the SM firmware transitions the guest VM to a running state 663. In this state, the SM firmware 132 no longer accepts commands to encrypt data at the northbridge 110 for the guest VM. This ensures that malicious software does not attempt to exploit or change the secure address space 125 by modifying it or overwriting it with other encrypted data. In the running state 663 the SM firmware 132 does accept deactivate and activate commands to temporarily suspend and resume execution of the guest VM. However, the SM firmware 132 does not permit decryption of data for the guest VM as part of the suspension of execution or permit encryption of data for the guest VM in conjunction with the resumption of execution, thereby protecting the secure address space 125 from unauthorized access.

In some embodiments, the SM firmware 132 supports sending and receiving guest VMs to and from other processing systems in a secure fashion, thereby supporting server migration and other operations. The SM firmware 132 supports sending a guest VM via a sending state 664. In particular, in response to a send start command from the hypervisor 243, the SM firmware 132 receives and verifies one or more of the PEK and chip keys for the processing system that is to receive the guest VM. In response to authenticating the one or more keys, the SM firmware transitions the guest VM to the sending state 664 and sends a copy of the guest VM to the target processing system. Upon completion, the sent copy of the VM is placed in a sent state 665, and the SM firmware 132 returns the guest VM at the processing system 100 to the running state 663.

To receive a copy of a guest VM, the SM firmware 132 receives a receive start command from the source processing system. The SM firmware 132 then transitions the guest VM to be sent from the sent state 665 to a receiving state 666. In some embodiments, prior to accepting the guest VM, the SM firmware 132 first authenticates a transport key provided by the source processing system. In response to authenticating the transport key, the SM firmware 132 generates an AS encryption key for the guest VM and provides it to the encryption module 115 to initiate encryption of secure information for the guest VM, in similar fashion as if the SM firmware 132 had received a command to launch the guest VM. Once all the secure information for the guest VM has been encrypted and the copy of the guest VM received, the hypervisor 243 can send a send finish command to the SM firmware 132, which in response transitions the received VM to the running state 663.

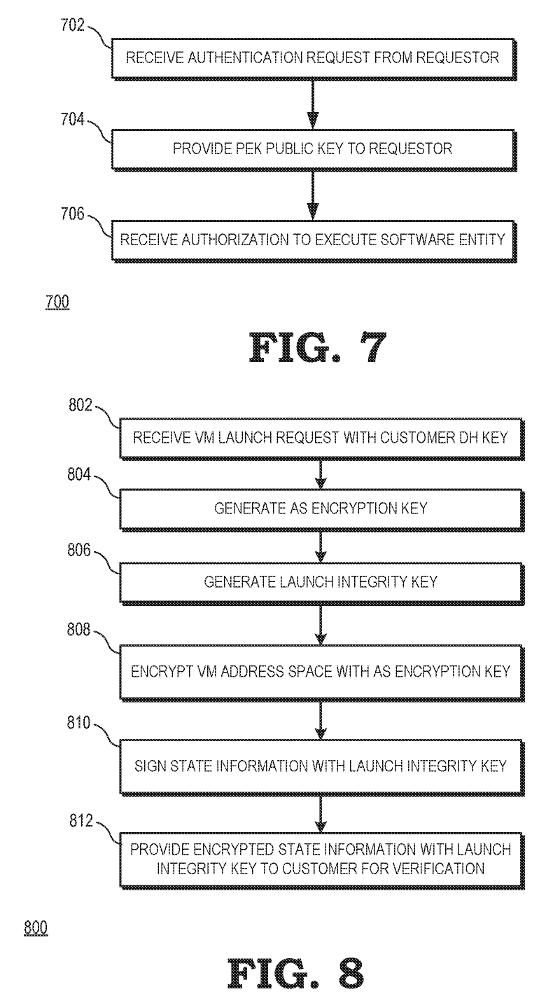

FIG. 7 illustrates a flow diagram of a method 700 of authenticating the processing system 100 to another processing system in accordance with some embodiments. At block 702, the SM firmware 132 receives a request to authenticate from another processing system, referred to herein as a requestor. The request to authenticate can be a precursor to other communications between the requestor and the processing system 100, such as a transfer of software or other data, establishment of a secure communication channel between the requestor and the processing system 100, and the like. In the example of FIG. 7, it is assumed that the request to authenticate is a precursor to granting permission to the processing system 100 to execute a software entity, such as a guest VM.

In response to the request to authenticate, at block 704 the security module 130 sends to the requestor the public PEK key it generated in the initialized state. The requestor authenticates the public PEK key, thereby authenticating that the processing system 100 includes the security module 130 and that the security module 130 was properly manufactured and sold to an authorized customer. In response to the requestor authenticating the public PEK key, it provides authorization to the processing system 100 to execute the software entity. The authorization can be in the form of a code without which the software entity will not proceed past a specified instruction, in the form of an image of the software entity itself or a portion thereof, in the form of data needed by the software entity to perform useful work, and the like. The processing system 100 receives the authorization at block 706. Note that if the public PEK is tampered with (e.g., by a malicious hypervisor or other software) or is otherwise incorrect, the requestor will not authenticate the public PEK key, and will therefore not provide authorization to the processing system to execute the software entity. The requestor and the security module 130 together thereby ensure that the software entity is not executed on a processing system that has been compromised by malicious software, or a processing system that does not include a security module as described herein.

FIG. 8 illustrates a flow diagram of a method 800 of encrypting an address space for a software entity (assumed for FIG. 8 to be a guest VM) at the processing system 100 in accordance with some embodiments. At block 802, the SM firmware 132 receives a request from a customer wishing to execute the guest VM. The request may be received, for example, via a wide area network such as the internet. The request is accompanied by a public key, referred to as the customer DH key, to indicate whether the request to execute the guest VM is authorized. The SM firmware 132 authenticates the customer DH key using its own PDH key. If the customer DH key is not authenticated, the SM firmware 132 indicates to the processor 102 that it is not to execute the guest VM.

If the customer DH key is authenticated, the method flow proceeds to block 804 and the SM firmware 132 generates an AS encryption key for the guest VM. The SM firmware 132 provides the generated AS encryption key directly to the encryption module 115 at the northbridge 110, such that the AS encryption key is not accessible by the hypervisor 243 or other software executing at the processor 102. In addition, at block 806 the SM firmware 132 uses the customer DH key to generate a launch integrity key according to a conventional key generation process. At block 808 the SM firmware 132 controls the encryption module 115 to encrypt the address space for the guest VM using the AS encryption key generated at block 804.

At block 810, the SM firmware 132 collects state information regarding the encryption of the address space, such as the number of memory pages encrypted, the order in which the memory pages were encrypted, and the like. The SM firmware 132 signs the collected state information using the launch integrity key. At block 812 the SM firmware 132 provides the signed state information to a processing system of the customer along with the launch integrity key. The customer processing system can authenticate the source of the signed state information, compare the signed state information to expected signed state information and, in the event of a mismatch, take remedial action, such as signaling to the SM firmware 132 that it should not permit the guest VM to execute, refusing to send to the guest VM encrypted data necessary for the guest VM to execute, and the like.

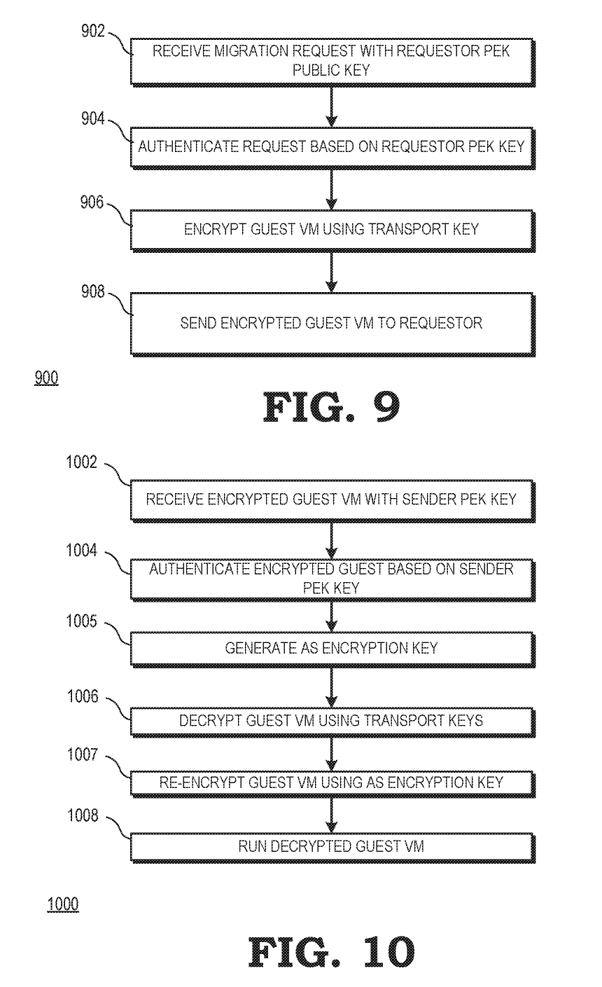

FIG. 9 illustrates a block diagram of a method 900 of sending a guest VM from the processing system 100 of FIG. 1 in accordance with some embodiments. At block 902 the processing system 100 receives, from another processing system referred to herein as the requestor, a request to send a copy of a guest VM. The request includes a public key, referred to as the requestor public PEK key. At block 904, the SM firmware 132 authenticates the request based on the requestor public PEK key and the platform private PEK key. If the request cannot be authenticated, the SM firmware 132 does not send the requested guest VM to the requestor.

If the request is authenticated, the method proceeds to block 906 and the SM firmware 132 encrypts an image of the requested guest VM, including any encrypted address space, using the transport key. At block 908 the SM firmware 132 sends the encrypted image to the requestor. The requestor can then decrypt the encrypted image and execute the guest VM.

FIG. 10 illustrates a block diagram of a method 1000 of receiving a guest VM at the processing system 100 of FIG. 1 in accordance with some embodiments. At block 1002 the processing system 100 receives an encrypted image of a guest VM from another processing system, referred to herein as the sender. The sender sends the guest VM to the processing system 100 with a public key, referred to herein as the sender PEK key. At block 1004 the SM firmware 132 authenticates the received guest VM based on the sender PEK key and the private PEK key stored at the security module 130. At block 1005 the SM firmware 132 generates an AS encryption key for the received guest VM. At block 1006 the SM firmware 132 decrypts the received guest VM, again based on the transport keys 135 and at block 1007 the SM firmware 132 re-encrypts the guest VM using the AS encryption key generated at block 1005. At block 1008 the SM firmware 132 indicates to the hypervisor 243 that the received guest VM can be executed at the processor 102.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating, at a security module of a processor independent of a processor core of the processor, a chip key based on a chip secret value uniquely associated with the processor;
generating, at the security module of the processor, a platform key pair based on the chip key; and
isolating, at the security module, the chip key and the platform key pair from software executing at the processor core.

2. The method of claim 1, wherein:
generating the chip key comprises generating the chip key in a first state of the security module; and
executing a software entity at the processor in a second state of the security module, wherein isolating the chip key comprises disallowing access to the chip key in the second state by disallowing commands from the software entity to generate the chip key.

3. The method of claim 2, wherein:
generating the platform key pair comprises generating the platform key pair in the first state of the security module.

4. The method of claim 2, further comprising:
in response to receiving a request at the security module to execute the software entity, generating an address space encryption key for the software entity; and
encrypting, at a memory controller of the processor, secure data associated with the software entity based on the address space encryption key.

5. The method of claim 4, further comprising:
monitoring, at the security module, state information for the encryption of the secure data; and
communicating the state information to a remote processing system for authentication of the software entity.

6. The method of claim 5, further comprising:
in response to receiving the request at the security module to execute the software entity, generating a launch integrity key at the security module; and
signing the state information with the launch integrity key prior to communicating the state information to the remote processing system.

7. The method of claim 4, further comprising:
in response to receiving a request to migrate the software entity from the processor:
generating a transport key at the security module; and
encrypting the secure data at the security module with the transport key.

8. The method of claim 4, further comprising:
in response to receiving a request to migrate the software entity to the processor:
generating a transport key at the security module;
receiving the secure data at the processor; and
decrypting the secure data at the security module with the transport key.

9. The method of claim 1, further comprising:
receiving a request to authenticate the processor; and
providing a public key of the platform key pair to the software executing at the processor in response to the request to authenticate the processor.

10. The method of claim 1, wherein the software comprises a hypervisor managing execution of one or more guest virtual machines at the processor.

11. A method comprising:
generating, at a security module of a processor, an address space encryption key for a software entity to be executed at the processor;
encrypting, at a memory controller of the processor, secure data associated with the software entity based on the address space encryption key;
monitoring, at the security module, state information for the encryption of the secure data; and
communicating the state information to a remote processing system for authentication of the software entity.

12. The method of claim 11, further comprising:
in response to receiving a request at the security module to execute the software entity, generating a launch integrity key at the security module; and
signing the state information based on the launch integrity key prior to communicating the encrypted state information to the remote processing system.

13. A device, comprising:
a processor core to execute a software entity; and
a security module independent from the processor core, the security module to:
generate a chip key based on a chip secret value uniquely associated with the processor;
generate a platform key pair based on the chip key; and
isolate the chip key and the platform key pair from the software entity executing at the processor core.

14. The device of claim 13, wherein the security module is to:
generate the chip key in a first state of the security module; and
permit execution of the software entity at the processor core in a second state of the security module, wherein isolating the chip key comprises disallowing a request to generate the chip key in the second state.

15. The device of claim 14 wherein the security module is to:
generate the platform key pair in the first state of the security module.

16. The device of claim 14 wherein the security module is to:
in response to receiving a request to execute the software entity, generate an address space encryption key for the software entity; and
encrypt, at a memory controller of the processor, secure data associated with the software entity based on the address space encryption key.

17. The device of claim 16, wherein the security module is to:
monitor state information for the encryption of the secure data; and
communicate the state information to a remote processing system for authentication of the software entity.

18. The device of claim 17, wherein the security module is to:
in response to receiving the request at the security module to execute the software entity, generate a launch integrity key at the security module; and
encrypt the state information based on the launch integrity key prior to communicating the encrypted state information to the remote processing system.

19. The device of claim 16, wherein the security module is to:
in response to receiving a request to migrate the software entity from the processor:
generate a transport key at the security module; and
encrypt the secure data at the security module with the transport key.

20. The device of claim 16, wherein the security module is to:
in response to receiving a request to migrate the software entity to the processor:
generate a transport key at the security module;
receive the secure data at the processor; and
decrypt the secure data at the security module with the transport key.
